(19) United States
(12) Patent Application Publication
(10) Pub. No.: US 2012/0100846 A1
(43) Pub. Date: Apr. 26, 2012

(54) METHOD AND DEVICE FOR ASSESSING CELL FAILURE BASED ON NON-ACQUISITION OF SYSTEM INFORMATION

(75) Inventors: Sukhdev Saini, Wednesbury (GB); Andrew John Farnsworth, Bromsgrove (GB)

(73) Assignee: RESEARCH IN MOTION LIMITED, Waterloo (CA)

(21) Appl. No.: 12/910,559

(22) Filed: Oct. 22, 2010

(51) Int. Cl. H04W 24/00

(52) U.S. Cl. 455/424

(57) ABSTRACT

Methods of assessing a cell to be a failed cell are provided that are based on the non-acquisition of system information. The method involves assessing whether or not a cell has failed as a function of whether, upon determining that system information needs to be acquired, the system information is acquired or not within a defined time period.

### FIELD

The application relates to methods and devices for assessing cell failure.

### BACKGROUND

UMTS (Universal Mobile Telecommunications System) uses a number of physical channels on to which data is mapped via transport channels, onto which in turn logical channels are mapped. A number of physical channels exist in the downlink, i.e. from the network towards the UEs (user equipments), providing data which enables detection, synchronisation, and acquisition of basic system information as well as data transfer when data is mapped for UE reception. These channels include amongst others the Primary Common Pilot Channel (P-CPICH) and Primary Common Control Physical Channel (Primary CCPCH or PCCPCH).

The Primary Common Pilot Channel is transmitted in the downlink by the Node B to the entire cell coverage area, and uses a fixed rate and channelization code across the network. This is used by the UEs within the network to identify of the Primary Scrambling Code used for scrambling Primary Common Control Physical Channel (PCCPCH) transmissions from the Node B. In addition the CPICH enables phase and power estimations to be made.

The Primary CCPCH is a fixed rate downlink physical channel used to carry the BCH (broadcast channel) transport channel, onto which the BCCH (broadcast control channel) logical channel is mapped. This logical channel carries the System Information for the cell which includes Core Network (CN), Radio Network and cell specific parameters to enable the UE to access the cell for service.

UMTS RRC (radio resource control) protocol [T525.331] (see for example TS25.331 v10.1.0 Radio Resource Control (RRC); Protocol specification (Release-10) publication date (2010-09), hereby incorporated by reference in its entirety) consists of 4 RRC connected mode states, CELL_DCH, CELL_FACH, CELL_PCH and URA_PCH states. In each of these states a number of measurements and procedures are defined within the GPP procedures.

Some of these procedures relate to handling mobility of the UE through the UTRAN (UMTS Terrestrial Radio Access Network). This is when the UE moves and passes across a cell of the UMTS technology whilst in RRC connected mode [as defined in T525.331]. The UTRAN configures the UE to perform specific measurements and based on these, defined RRC procedures determine how the UE moves in a reliable manner to neighbouring cells whilst maintaining a connection between the UE and the network. In some RRC states (specifically CELL_FACH, CELL_PCH or URA_PCH) i.e. those without a dedicated transport channel, the UE performs its own mobility procedures that are based on the measurements performed and in accordance with the measurement configuration setup by the UTRAN from the serving RNC (radio network controller), the UE decides when coverage of the existing serving cell is not good enough and when a new neighbouring cell has achieved a level whereby it may be chosen to be the new serving cell. This process is known as reselection. The UE evaluation process is defined in [T525.304] (see, for example TS25.304 v 9.3 User Equipment (UE) procedures in idle mode and procedures for cell reselection in connected mode (Release-9) publication date (2010-09), hereby incorporated by reference in its entirety) whereby using the measured reselection criteria a new cell is selected according to the configured radio measurements. In other RRC states, for example CELL_DCH, the network initiates and controls if and when the mobile station changes cells by way of a handover.

The UE measurement and reselection performance criteria are defined in [T525.133] (see for example TS25.133 v 9.4.0 Requirements for support of radio resource management (FDD) (Release-9) publication date (2010-09), hereby incorporated by reference in its entirety) where associated measurement and processing performance attributes are defined with a view to ensuring a minimum level of performance for the reselection behaviour of the UE thereby guaranteeing the UE and associated user a reliable level of performance.

In CELL_FACH state [TS25.133 section 5.5.2] defines that the measurements CPICH Ec/Io and CPICH RSCP (received signal code power) shall be used for cell reselection to another FDD (frequency division duplexing) cell, PCCPCH RSCP shall be used for cell reselection to a TDD (time division duplexing) cell and GSM carrier RSSI (received signal strength indication) shall be used for cell reselection to a GSM cell.

The UE also uses these measurements to determine whether the cell selection criteria (S criteria) [defined in T525.304] are achieved. In one aspect should the UE lose the radio coverage of the serving cell, specific measurement behaviour and associated performance is defined in [25.133 section 5.5.2.3], whereby once the UE detects that the S criteria are not fulfilled it should continue to assess the current cell radio measurements whilst also searching for a neighbour cell as indicated in the received measurement control message. If for 4 seconds the UE fails to find any new suitable cell it considers itself “out of service area”. At this point the UE initiates the cell selection procedure for the selected PLMN, namely the current registered PLMN, in order to locate, camp on and establish a new connection.

The UE as part of the cell selection behaviour that occurs after the 4 seconds referred to above will initially use any previously stored information by performing the “stored information cell selection” procedure as defined in [T525.304] then if this should fail then the UE will adopt the “initial cell selection” procedure also as defined in [T525.304].

When a suitable cell is selected and if the UE considers itself to be “Out of Service Area” whilst it is selecting the cell then the behaviour, in the case the selected cell is a 3G UTRAN cell, to the UE sends an RRC: Cell Update message with a cell update cause set to “re-entered service area”, as defined in [T525.331].

As can be envisaged from the above description for a UE which is in a cell that has failed then the time to detect when “Out of Service Area” has occurred and then to subsequently locate and camp on a new cell will exceed 4 seconds. In general the UE needs to first detect that the condition for triggering the “Out of Service Area” evaluation period and then once this occurs it needs continue to monitor the cell measurements and evaluate whether the S criteria continues to not be met for 4 seconds before declaring the “Out of Service Area” condition. Also during this continuous 4 second evaluation period the UE is expected to scan the configured neighbouring cells in order to find a suitable cell that it may reselect to.

If no suitable cell is found this condition is confirmed and the UE determines that it is “Out of Service Area” after which it will initiate a cell selection procedure according to [T525.304] to find a suitable cell on which to camp.

The process described above is specifically for the UE behaviour in RRC state CELL_FACH, however similar behaviour is present for other RRC states.

For example in CELL_PCH and URA_PCH states, the S criteria is evaluated for the specified number of DRX (discontinuous reception) cycles with the associated degree of measurement filtering [25.133]. If however, after this evaluation the serving cell is found to not satisfy the selection criteria S then the UE will initiate checking the neighbour cells for 12 seconds. If no neighbour cells are determined to be suitable then the UE considers itself to be “Out of Service Area” and will initiate cell selection procedures.

Also if during a state transition from CELL_DCH to CELL_FACH, CELL_PCH or URA_PCH the UE is unable to find a cell then the UE determines it is “Out of Service Area”.

### BRIEF DESCRIPTION OF THE DRAWINGS

FIG. 1 is a flowchart of a method of assessing a cell as a failed cell based on non-acquisition of system information;

FIG. 2 is a flowchart of another method of assessing a cell as a failed cell based on non-acquisition of system information;

FIG. 3 is a flowchart of a method of attempting to camp on cells following assessing a serving cell to have failed based on non-acquisition of system information;

FIG. 4 is a block diagram of a user equipment; and

FIG. 5 is a block diagram of a mobile station.

### DETAILED DESCRIPTION

It should be understood at the outset that although illustrative implementations of one or more embodiments of the present disclosure are provided below, the disclosed systems and/or methods may be implemented using any number of techniques, whether or not currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The process described above for CELL_FACH takes more than 4 seconds and results in an interruption to any ongoing data session that the UE may have been undertaking during the CELL_FACH connection to the failed UTRA cell. The similar process for CELL_PCH and URA_PCH takes more than 12 seconds.

Taking more than 4 seconds, or more than 12 seconds as the case may be, to determine whether to a serving cell is available may not be optimum in terms of discovering an available cell from which to continue service, in this case of no coverage.

Procedures are provided that may reduce the disruption to the ongoing connection between the UE and the network either for the case of a failed cell or in the case of loss of serving cell coverage and provide mechanisms for selecting a new cell. The mechanism may result in the selection of a new cell more quickly than would be the case if the UE waited for the standardised delay associated with the “Out of Service Area” determination [25.133] in order to continue the ongoing data connection. In some embodiments, these procedures are applied while in a connected mode state other than CELL_DCH.

According to a broad aspect, the disclosure provides a method in a user equipment, the method comprising: assessing whether or not a cell has failed as a function of whether, upon determining that system information needs to be acquired, the system information is acquired or not within a defined time period.

Another broad aspect provides a user equipment configured to implement the method summarized above, or any other method described or claimed herein.

Another broad aspect provides a computer storage medium having computer executable instructions stored thereon that, when executed by a user equipment, cause the user equipment to perform the method summarized above, or any other method described or claimed herein.

A method of assessing a cell to be a failed cell is provided. This method can be applied in respect of the current serving cell, or in respect of another cell such as a neighbour cell, for example a neighbour cell that has been configured in the sense that the UE has been instructed to perform measurements for the neighbour cell.

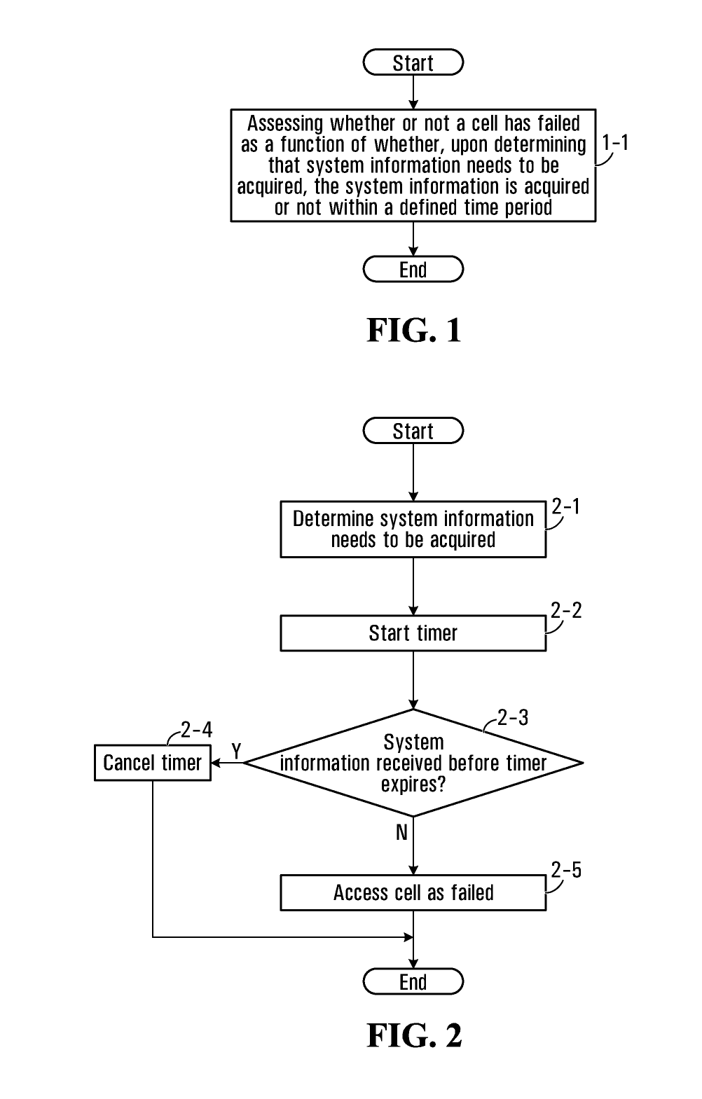

The method of assessing cell failure is provided that is based on non-acquisition of system information. With reference to FIG. 1, the method involves assessing whether or not a cell has failed as a function of whether, upon determining that system information needs to be acquired, the system information is acquired or not within a defined time period, at block 1-1.

For the purpose of this description, a “failed” cell is a cell that is assessed as such based on the non-acquisition of system information. Such a cell may be a cell within which the base station has physically failed, or a cell for which the UE has become out of coverage of the base station of the cell.

There are various instances in which the UE may determine that system information needs to be acquired. For the serving cell, the UE may need to update system information because its current information has expired. The UE may need to update system information because the network has notified the UE that the system information has changed. For neighbour cells, the UE may attempt to acquire system information, for example, when attempting to perform cell reselection.

In some embodiments, the method involves upon determining that system information needs to be acquired, starting a timer. If the system information is acquired, the UE cancels the timer. The UE then assesses whether the cell has failed or not as a function of whether the timer expires. In particular, if the timer does expire, then the cell assesses the cell as a failed cell. With reference to FIG. 2, a particular example implementation will now be described. This method involves determining that system information needs to be acquired in block 2-1; starting a timer at block 2-2; if system information is acquired (yes path block 2-3), cancelling the timer at block 2-4; if the system information is not acquired before the timer expires (no path block 2-3), assessing the cell as failed at block 2-5.

In some embodiments, the timer has a timeout value that differs for different types of system information to be acquired.

In a first specific example, if the UE is attempting to acquire the Master Information Block (MIB) and the Scheduling Blocks (SBs) then the UE starts a timer which is set to a first timeout value, for example two seconds, and tries to acquire these blocks. If the UE is unable to locate and read the MIB and SBs before the timer expires, the system information is considered to be in error UE assesses cell failure to have occurred.

In a second specific example, if the UE is attempting to acquire the System Information Blocks (SIBs) then the UE starts a timer which is set to a second timeout value, for example 15 seconds, and tries to acquire these blocks. In one example the System Information Blocks are the required System Information Blocks as indicated in the MIB. In another example the System Information Blocks if not received before in that cell are System Information Block Type 1, System Information Block Type 3, System Information Block Type 5, System Information Block Type 7 and System Information Block Type 11. If the UE is unable to locate and read the determined SIBs before the timer expires, the system information is considered to be in error and the UE assesses cell failure to have occurred.

### Follow-on Behaviour

In some embodiments, upon assessing a cell (the serving cell or a neighbour cell) to have failed using this mechanism, the UE then bars this cell (i.e. does not attempt to camp on the cell) for a defined period, for example a period Tbarred (as defined in TS25.304) which is set to the minimum value of 10 seconds. Then, whenever the UE attempts to camp on another cell, for example as part of a reselection process, the UE refrains from attempting to acquire a given cell so long as the cell is barred. Advantageously, removing a cell from consideration may reduce battery drain compared to repeatedly measuring the cell and trying to read its PCCPCH.

For the purpose of this description, a UE is camped on a cell after the UE has completed the cell selection or a cell reselection process and has chosen a cell; at that point the UE monitors system information and (in most cases) paging information.

In order to successfully camp on a cell, for example as part of a cell selection or cell reselection process, various steps are taken. The process of “attempting to camp” on a cell involves performing one or more of the steps necessary to successfully camp on the cell. If less than all of the necessary steps are able to be successfully completed, then the attempt has failed. A specific example of the steps involved in attempting to camp on a cell can be found in TS25.304 but it is to be clearly understood that the disclosure is not limited to this example.

If the serving cell is assessed to have failed, the UE can then attempt to camp on another candidate cell. A cell is a candidate cell if it satisfies a set of basic criteria. These may for example be based on set minimum values for measurements taken each cell. Satisfaction of the S-criteria is a specific example. In a specific example, the UE attempts to camp on a configured neighbour cell that is not barred. For example, this might be the next neighbour cell ranked according to a ranking criterion, for example based on the measurements of neighbour cell using serving cell measurements as a reference point.

In a first specific example, after assessing failure of the serving cell using this mechanism, the UE attempts a targeted search to identify and camp on a cell from which to continue the service. In an example of a targeted search the UE utilizes predetermined knowledge of the PLMN and its configuration of frequencies, Radio Access Technologies e.g. UMTS, GERAN, CDMA2000 etc. possibly in combination with any neighbour cell information stored from the previously accessed cells on the PLMN.

In a second specific example, after assessing failure of the serving cell using this mechanism the UE attempts to camp on a candidate neighbour cell that has not been barred. Upon failure to camp on such a cell, the UE attempts a targeted search to identify and camp on a cell from which to continue the service. An example of a targeted search is given above.

In a third example, after assessing failure of the serving cell using this mechanism the UE attempts to camp on a candidate neighbour cell that has not been barred, based on previous cell measurements; these may be ranked according to the measurements. The UE may attempt to camp on the candidate neighbour cells in order of their rankings. Note that the process of attempting to camp on these cells may result in one or more of them being barred due to non-acquisition of system information. If no suitable cell is found, then if there are neighbour cells that are not considered to be barred, then measure them for a period (e.g. 4s in Cell_FACH, 12s in Idle, Cell_PCH or URA_PCH) and attempt to camp on a candidate cell, for example the best cell in accordance with the measurements, if one becomes available, e.g. by getting stronger and so satisfy the S criteria. If after the period still no suitable cell is found, or there are no neighbour cells that are not considered to be barred, then start searching for a cell more widely than amongst just the neighbour cells.

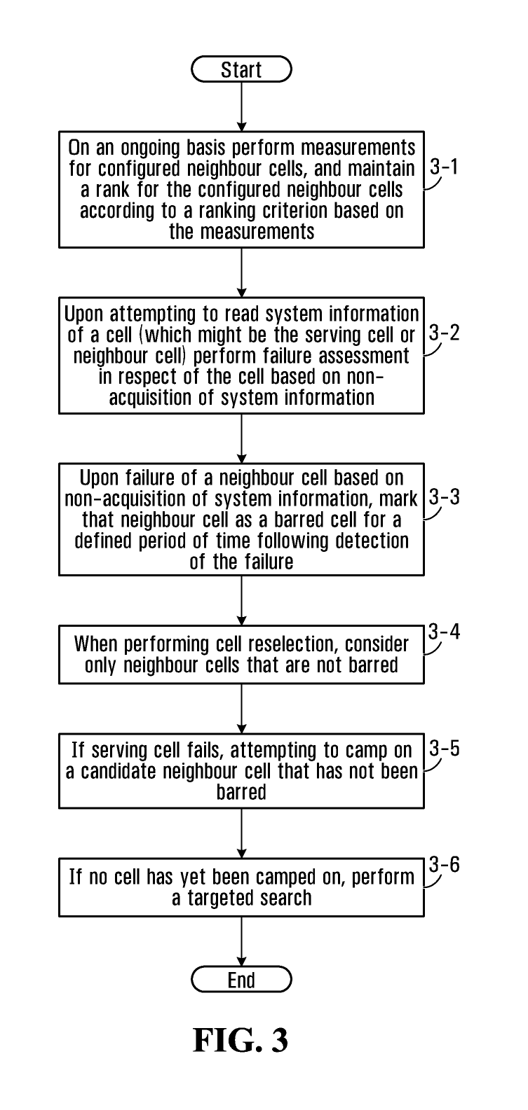

With reference to FIG. 3, the following is a specific example of a process flow:

on an ongoing basis perform measurements for configured neighbour cells, and maintain a rank for the configured neighbour cells according to a ranking criterion based on the measurements (block 3-1);

upon attempting to read system information of a cell (which might be the serving cell or neighbour cell) perform failure assessment in respect of the cell based on non-acquisition of system information (block 3-2);

upon failure of a cell based on non-acquisition of system information, mark that cell as a barred cell for a defined period of time following detection of the failure (block 3-3);

when performing cell reselection, consider only cells that are not barred (block 3-4).

In some implementations, the process flow continues as follows:

if the serving cell fails, attempting to camp on a candidate neighbour cell that has not been barred, for example the highest ranked candidate neighbour cell (block 3-5).

In some implementations, the process flow continues as follows:

if no cell has yet been camped on after performing block 3-5, perform a targeted search (block 3-6).

In another embodiment, rather than executing a targeted search following block 3-5, if there are neighbour cells that are not considered to be barred, then the UE measures them for a defined period (e.g. 4s in Cell_FACH, 12s in Idle, Cell_PCH or URA_PCH) and attempts to camp on a candidate neighbour cell if there is one. Then, if after the period still no neighbour cell is suitable, or there are no neighbour cells that are not considered to be barred, then start searching for a cell in a targeted manner more widely than amongst just the neighbour cells.

It will be appreciated that that any module, component, or device exemplified herein that executes instructions may include or otherwise have access to computer readable storage medium or media for storage of information, such as computer readable instructions, data structures, program modules, or other data. A non-exhaustive list of examples of computer readable storage media include magnetic cassettes, magnetic tape, magnetic disk storage or other magnetic storage devices, optical disks such as CD-ROM, digital versatile disks (DVD) or other optical storage, volatile and non-volatile, removable and non-removable media implemented in any method or technology, RAM, ROM, EEPROM, flash memory or other memory technology. Any such computer storage media may be part of the device or accessible or connectable thereto. Any application or module herein described may be implemented using computer readable/executable instructions that may be stored or otherwise held by such computer readable storage media.

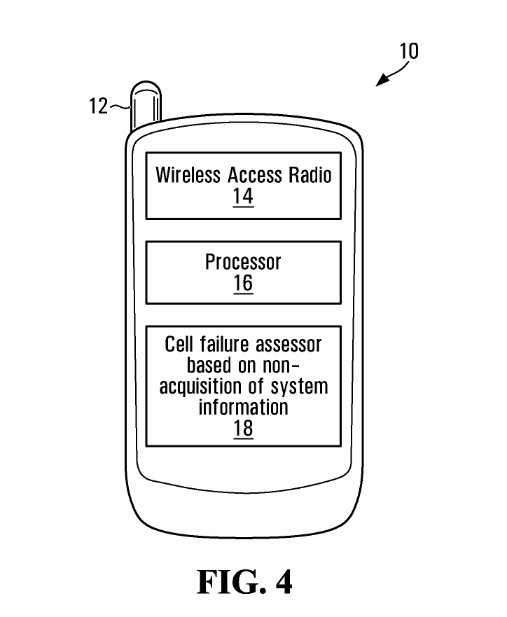

Referring to FIG. 4, shown is a block diagram of a UE generally indicated at 10. The UE has at least one antenna 12. The UE has at least one wireless access radio 14 and a processor 16. The UE has a CEFBNSI (cell failure assessor based on non-acquisition of system information) 18. The CFBNSI functions to assess cell failure based on non-acquisition of system information, or example, using one of the methods described above. The CFBNSI may be implemented as software in combination with appropriate hardware for running the software, hardware, firmware, or a combination thereof. The UE may have other components, not shown in the interest of brevity.

### Another Mobile Device

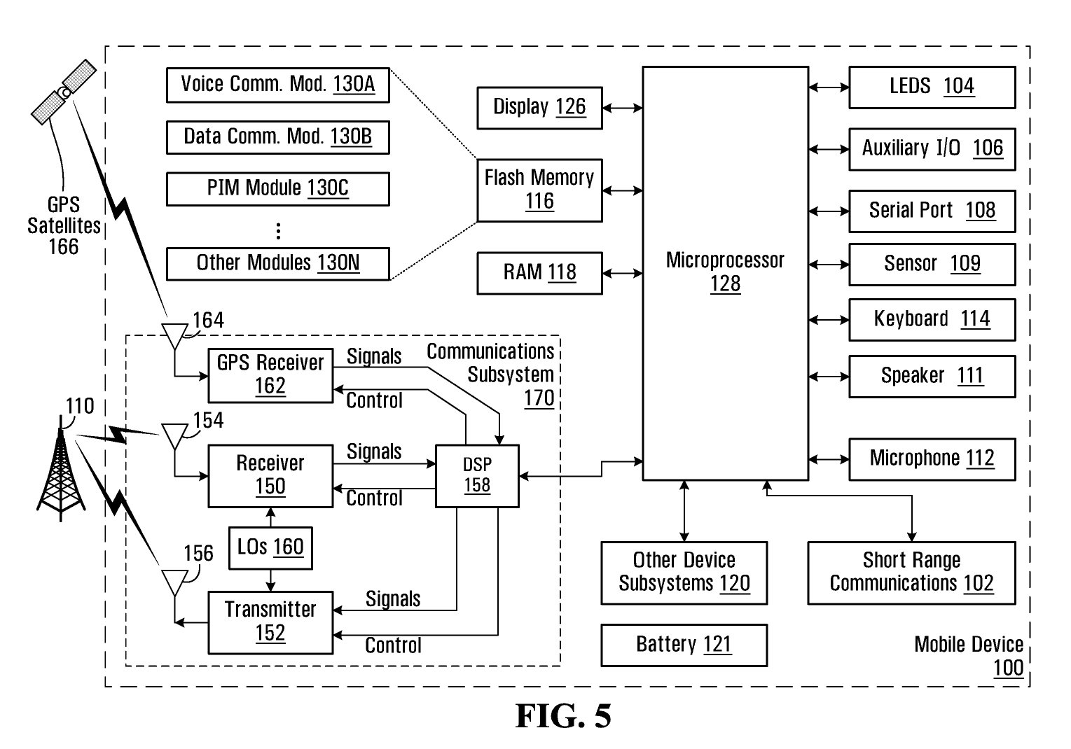

Referring now to FIG. 5, shown is a block diagram of a mobile device 100 that is an example of a user equipment that may implement any of the methods described herein. The mobile device 100 is shown with specific components for implementing features similar to those of the mobile device 30 shown in FIG. 1. It is to be understood that the mobile device 100 is shown with very specific details for exemplary purposes only.

The mobile device 100 has a housing that may be elongated vertically, or may take on other sizes and shapes (including clamshell housing structures). The keyboard 114 may include a mode selection key, or other hardware or software for switching between text entry and telephony entry. Alternatively, the mobile device 100 may have a housing that does not take on other sizes and shapes.

A microprocessor 128 is shown schematically as coupled between a keyboard 114 and a display 126. The microprocessor 128 is a type of processor with features similar to those of the processor 32 of the mobile device 30 shown in FIG. 1. The microprocessor 128 controls operation of the display 126, as well as overall operation of the mobile device 100, in response to actuation of keys on the keyboard 114 by a user.

In addition to the microprocessor 128, other parts of the mobile device 100 are shown schematically. These include: a communications subsystem 170; a short-range communications subsystem 102; the keyboard 114 and the display 126, along with other input/output devices including a set of LEDs 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some embodiments a two-way radio frequency (RF) communication device having voice and data communication capabilities. In addition, the mobile device 100 in some embodiments has the capability to communicate with other computer systems via the Internet.

Operating system software executed by the microprocessor 128 is in some embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some embodiments capable of organizing and managing data items, such as e-mail, calendar events, voice mails, appointments, and task items. The PIM application is also in some embodiments capable of sending and receiving data items via a wireless network 110. In some embodiments, the data items managed by the PIM application are seamlessly integrated, synchronized and updated via the wireless network 110 with the device user's corresponding data items stored or associated with a host computer system.

Additional software modules, illustrated as another software module 130N, may be installed during manufacture. The software modules may, for example, include one or modules that control the execution of the methods of assessing the failure of cells based on non-acquisition of system information, described previously. Note that the implementations described with reference to FIG. 5 are very specific for exemplary purposes. For example, alternative implementations are possible in which the method of assessing the failure of cells based on non-acquisition of system information is not implemented as software and stored on the flash memory 116. More generally, the methods may be implemented as software running on appropriate hardware, hardware, firmware, or any appropriate combination thereof.

Communication functions, including data and voice communications, are performed through the communication subsystem 170, and possibly through the short-range communications subsystem 102. The communication subsystem 170 includes a receiver 150, a transmitter 152, a GPS receiver 162, and one or more antennas, illustrated as a receive antenna 154, a transmit antenna 156, and a GPS antenna 164. In addition, the communication subsystem 170 also includes a processing module, such as a digital signal processor (DSP) 158, and local oscillators (LOs) 160. The communication subsystem 170 has features similar to those of the wireless access radio 31 of the mobile device 30 shown in FIG. 1.

The specific design and implementation of the communication subsystem 170 is dependent upon the communication network in which the mobile device 100 is intended to operate. For example, the communication subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Examples of CDMA include 1X and 1x EV-DO. The communication subsystem 170 may also be designed to operate with an 802.11 Wi-Fi network, and/or an 802.16 WiMAX network. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150, the transmitter 152, and the GPS receiver 162. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using the keyboard 114 and/or some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

Location determination using GPS technology involves receiving GPS signals from GPS satellites 166 on the antenna 164. The GPS signals are received using the GPS receiver 162 and processed by the DSP 158. Typically, GPS signals from at least four satellites are processed. Further details of GPS are omitted for simplicity.

The short-range communications subsystem 102 enables communication between the mobile device 100 and other proximate systems or devices, which need not necessarily be similar devices. For example, the short range communications subsystem may include an infrared device and associated circuits and components, or a Bluetooth™ communication module to provide for communication with similarly-enabled systems and devices.

Numerous modifications and variations of the present disclosure are possible in light of the above teachings. It is therefore to be understood that within the scope of the appended claims, the disclosure may be practiced otherwise than as specifically described herein.

1. A method in a user equipment (UE), the method comprising:
assessing whether or not a cell has failed as a function of whether, upon determining that system information needs to be acquired, the system information is acquired or not within a defined time period.

2. The method of claim 1 wherein assessing whether or not a cell has failed as a function of whether, upon determining that system information needs to be acquired, the system information is acquired or not within a defined time period further comprises:
upon determining that system information needs to be acquired, starting a timer;
if the system information is acquired, cancelling the timer; and
assessing whether the cell has failed or not as a function of whether the timer expires.

3. The method of claim 2 wherein the timer has a timeout value that differs for different types of system information to be acquired.

4. The method of claim 3 wherein the timer has a first timeout value for a master information block and scheduling blocks, and has a second timeout value for system information blocks.

5. The method of claim 1 further comprising:
upon assessing that the cell has failed as a function of system information acquisition, barring the UE from camping on the cell for a defined time period.

6. The method of claim 1 further comprising:
performing the method for each cell for which system information needs to be acquired.

7. The method of claim 1 further comprising:
whenever the UE attempts camping on another cell, the UE refrains from attempting to camp on a given cell so long as the cell is barred.

8. The method of claim 1 further comprising:
upon assessing the serving cell to have failed, attempting to camp on at least one neighbour cell that has not been barred.

9. The method of claim 8 further comprising:
performing measurements in respect of a set of neighbour cells;
ranking the cells based on the measurements;
wherein attempting to camp on at least one neighbour cell that has not been barred comprises attempting to camp on at least one neighbour cell that has not been barred in order of their ranking.

10. The method of claim 1 further comprising:
after assessing failure of the serving cell using this mechanism, the UE attempting a targeted search to identify and camp on a cell from which to continue the service.

11. The method of claim 1 further comprising:
after assessing failure of the serving cell using this mechanism the UE attempting to camp on any neighbour cell that has not been barred;
upon failure to camp on such a cell, the UE attempts a targeted search to identify and camp on a cell from which to continue the service.

12. The method of claim 1 further comprising:
after assessing failure of the serving cell based on non-acquisition of system information, the UE attempting to camp on a candidate neighbour cell that has not been barred, based on existing measurements;
if no such cell exists, then if there are neighbour cells that are not considered to be barred, the UE measuring the neighbour cells that are not considered to be barred for up to a defined period and attempting to identify a candidate cell, and attempting to camp on such a candidate cell if there is one;
if after the defined period still no suitable neighbour cell is found, or there are no neighbour cells that are not considered to be barred, the UE starting to search for a cell more widely than amongst just the neighbour cells.

13. The method of claim 1 further comprising:
on an ongoing basis perform measurements for configured neighbour cells, and maintain a rank of the configured neighbour cells according to a ranking criterion based on the measurements;
upon attempting to read system information of a neighbour cell, performing failure assessment in respect of the cell based on non-acquisition of system information;
upon failure of a neighbour cell based on non-acquisition of system information, marking that neighbour cell as a barred cell for a defined period of time following detection of the failure;
when performing cell reselection, considering only neighbour cells that are not barred.

14. The method of claim 13 further comprising:
if the serving cell fails, attempting to camp on a candidate neighbour cell that has not been barred.

15. The method of claim 14 further comprising:
if, after attempting to camp on any candidate neighbour cell that has not been barred, no cell has been successfully camped on, performing a targeted search.

16. The method of claim 14 further comprising:
if, after attempting to camp on any candidate neighbour cell based on existing measurements that has not been barred, no cell has been successfully camped on, for up to a defined time period measuring neighbour cells that have not been barred, and attempting to camp on a candidate cell if there is one;
if, after the defined period, no cell has been successfully camped on, performing a targeted search.

17. A user equipment configured to implement the method of claim 1.

18. A computer storage medium having computer executable instructions stored thereon that, when executed by a user equipment, cause the user equipment to perform the method of claim 1.

19. A user equipment comprising:
at least one antenna;
at least one wireless access radio;
a processor; and
a CFABNSI (cell failure assessor based on non-acquisition of system information) that assesses whether or not a cell has failed as a function of whether, upon determining that system information needs to be acquired, the system information is acquired or not within a defined time period.

20. The user equipment of claim 19 wherein the CFABNSI, upon assessing that the cell has failed as a function of system information acquisition, bars the UE from camping on this cell for a defined time period.

21. The user equipment of claim 20 wherein, when attempting to camp on a cell, the UE refrains from attempting to camp on a given cell so long as the given cell is barred.
